(19) United States
(12) Patent Application Publication
(10) Pub. No.: US 2019/0360686 A1
(43) Pub. Date: Nov. 28, 2019

(54) LUMINAIRE WITH BIOSENSOR

(71) Applicant: ABL IP Holding LLC, Conyers, GA (US)

(72) Inventors: Kathryn Margaret PENDO, Silver Spring, MD (US); David P. RAMER, Reston, VA (US); Jack C. RAINS, JR., Sarasota, FL (US); Min-Hao Michael LU, Castro Valley, CA (US); James Benton FRENCH, Carmel, IN (US)

(21) Appl. No.: 15/986,190

(22) Filed: May 22, 2018

(51) Int. Cl. F21V 33/00; G08B 21/14

(52) U.S. Cl. CPC F21V 33/0076; F21Y 2113/10; G08B 21/14; F21V 33/0096

(57) ABSTRACT

Disclosed are examples of luminaires that provide light for general illumination and detect toxins in air via a biosensor. In the examples, a luminaire may include a light source configured to illuminate a space, a biosensor configured to detect toxins in the air, and an air circulation system. The light source may be configured to illuminate a space in which the luminaire is located with general illumination light. The biosensor may include an air permeable membrane, a substrate, and a microorganism that responds to the presence of a toxin in the air that comes in contact with the microorganism. A sensor may detect the response by the microorganism of the presence of the toxin, and output a signal indicating the presence of the toxin based on the detected response. A processor coupled to the luminaire may receive the outputted sensor signal and output a report of the toxin.

### TECHNICAL FIELD

The examples described herein relate to luminaires that include a biosensor capable of detecting the presence of a toxin in air.

### BACKGROUND

As awareness of the effects of the environment on people's health has increased, one area that has garnered greater attention is the quality of the air that people breathe. It is well documented that buildings may develop into “sick buildings” in which mold and other toxins may be present. For example, some work places, such as industrial areas and laboratories, may have toxic, or potentially toxic, chemicals, materials and gases present that may adversely affect the air quality within the work place. Other habitable spaces, such as hospitals, schools, and dormitories, may have airborne impurities and/or airborne bacteria.

There is a continuing need to monitor and detect toxins from the air remains an important goal as furniture and floor materials can produce volatile organic compound (VOCs) that are harmful or even toxic to people and animals. In addition, the ability to detect airborne toxins is an important aspect of maintaining air quality and alerting people of potentially hazardous conditions.

### SUMMARY

Hence, there is room for further improvement in air quality detection systems to maintain air quality within a space, and provide people within the space with an alert of potentially hazardous conditions.

Provided is an example of a luminaire that includes a light source configured to illuminate a space, a biosensor capable of producing an observable indication in response to the presence of a toxin in the air, and an air circulation system capable of drawing air into contact with the biosensor.

An example of a system is also provided. The example system includes a luminaire and a controller. The luminaire includes a light source configured to illuminate a space, a biosensor capable of producing an observable indication in response to the presence of a toxin in the air, and an air circulation system capable of drawing air into contact with the biosensor. The controller is coupled to control light from the light source and control the air circulation system.

Also provided is an example of a method that includes emitting light from a light source in a luminaire to illuminate a space. The method also includes drawing air from at least a portion of the space illuminated by the light source into contact with a biosensor in the luminaire, and, in response to a presence of a toxin in the drawn in air, producing an observable indication of the presence of the toxin.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

### BRIEF DESCRIPTION OF THE DRAWINGS

The drawing figures depict one or more implementations in accordance with the present concepts, by way of example only, not by way of limitations. In the figures, like reference numerals refer to the same or similar elements.

FIG. 1 illustrates a block diagram system example incorporating a luminaire containing a biosensor.

FIG. 2 illustrates a cross sectional view of an example of a luminaire containing a biosensor.

FIG. 3A illustrates an example of a biosensor usable in the luminaire example of FIG. 2.

FIG. 3B illustrates a plan view of an example of a cylindrical biosensor configuration suitable for use in the luminaire examples of FIGS. 1 and 2.

FIG. 3C illustrates a plan view of a rectangular biosensor configuration suitable for use in the luminaire examples of FIGS. 1 and 2.

FIG. 4 illustrates a diagram of an example of a central processing unit for controlling operation of an example of a luminaire, such as those described with reference to FIGS. 1, 2 and 4.

FIG. 5 illustrates a flowchart of an example process utilizing examples of the biosensor described with reference to FIGS. 1-3C.

### DETAILED DESCRIPTION

The examples described herein are directed to luminaires, e.g., light fixtures, which are able to remove impurities, volatile organic compounds (VOC) and the like from the environment in which the luminaire is located, to systems including one or more such luminaires and method of operating a luminaire or system. Thus, in addition to providing ambient light for a habitable area, the luminaires are also capable of detecting the presence of a toxin in the air as described in more detail herein.

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The examples below relate to improved hardware and techniques for combined general illumination and biosensors configured to sample air in proximity to a location of a luminaire for the presence of an air-borne toxin. In a simple example, a system may include a luminaire and a controller. The luminaire includes a light source and a biosensor. The controller may be incorporated in the luminaire or separate from the luminaire. Systems, however, may include some number of luminaires controlled by one controller or systems involving a number of networked controllers and luminaires associated with or incorporating the controllers. Systems may also include or communicate with other relevant equipment such as environmental monitoring devices, heating, ventilation and air conditioning (HVAC) equipment, and/or higher layer computer equipment such as various user terminal devices on or off the premises and/or a building control and automation system (BCAS).

The term “luminaire,” as used herein, is intended to encompass essentially any type of device that processes energy to generate or supply artificial light, for example, for general illumination of a space intended for occupancy or observation, typically by a human that can take advantage of or be affected in some desired manner by the light emitted from the device. However, a luminaire may provide light for use by automated equipment, such as sensors, monitors, robots, etc. that may occupy or observe the illuminated space, instead of or in addition to light provided for a human. In most examples, the luminaire(s) illuminate a space or area of a premises to a level useful for a human occupant in or passing through the space, e.g. general illumination of a room, a corridor in a building or of an outdoor space such as a street, sidewalk, parking lot, performance venue or the like.

The general illumination light output of a luminaire, for example, may have an intensity and/or other characteristic(s) that may satisfy an industry acceptable performance standard for a general illumination lighting application. The lighting performance standard for the general illumination may vary for different uses or applications of the illuminated space, for example, as between residential, office, manufacturing, warehouse, hospital, nursing home, or retail spaces.

Terms such as “artificial lighting,” as used herein, are intended to encompass essentially any type of lighting that a device produces by processing of electrical power to generate the light. An artificial lighting device, for example, may take the form of a lamp, light fixture, or other luminaire that incorporates suitable light sources, where each light source by itself contains no intelligence or communication capability, such as one or more light emitting diodes (LEDs) or the like, or a lamp (e.g. “regular light bulbs”) of any suitable type.

In several illustrated examples, such a luminaire may take the form of a light fixture, such as a pendant, a drop light, a downlight, a wall wash light, or the like. Of course, other fixture-type luminaire mounting arrangements are possible. For example, at least some implementations of the luminaire may be surface mounted to or recessed in a wall, ceiling or floor. Orientation of the example luminaires and components thereof are shown in some of the drawings and described below by way of non-limiting examples only. The luminaire with the lighting component(s) may take other forms, such as lamps (e.g. table, floor, or street lamps) or the like. Additional devices, such as fixed or controllable optical elements, may be included in the luminaire, e.g. to distribute light output from the light source in a particular manner.

Terms such as “lighting device” or “lighting system,” as used herein, are intended to encompass essentially any combination of an example of a luminaire discussed herein with other elements such as electronics of a controller and/or support structure, to operate and/or install the particular luminaire implementation. Such electronics hardware, for example, may include some or all of the appropriate driver(s) for the illumination light source, any associated control processor or alternative higher level control circuitry, and/or data communication interface(s). The electronics for driving and/or controlling the lighting component(s) may be incorporated within the luminaire or located separately and coupled by appropriate means to the light source component(s) of the luminaire.

As used herein, the term “biosensor” refers to an assembly that samples air in the vicinity of a light fixture coupled to the biosensor for the detection of an analyte that combines a biological component with a physicochemical detector that produces an observable or detectable response to the detection of the analyte. In the disclosed examples, the biological component is a microorganism that is capable of responding to the presence of a toxin in the air. Such biosensors are often referred to as “whole-cell biosensors.” The biosensor being capable of producing an observable indication in response to the presence of a toxin in the air. Biosensors are well-known in the art and generally refer to devices that respond to toxins in the air by a biological operation of the microorganism. The biosensors of the examples described herein may be used for this purpose as discussed below with reference to the respective examples.

The term “sampling air” generally means that a microorganism, such as bacteria, algae, or fungi, reacts to the air that comes into contact with the microorganism for the detection of the presence of toxins in the air. That is, the microorganism is capable of responding to the presence of toxins in the air by generating an observable indication of the presence of the toxin.

The disclosed examples are now described in more detail with reference to the drawings.

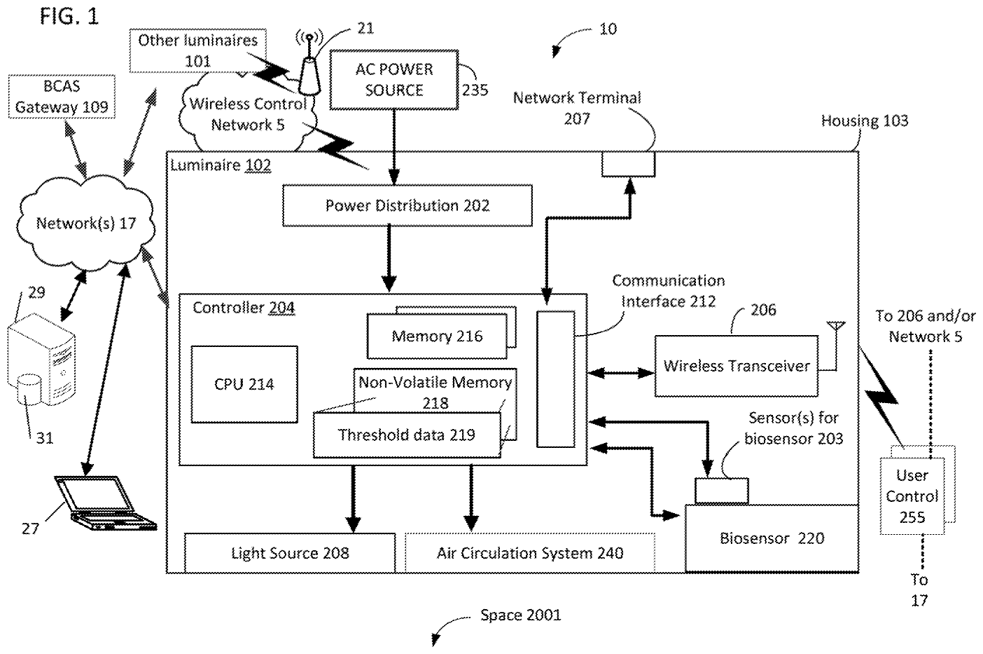

FIG. 1 is a functional block diagram illustrating details of a luminaire incorporating a biosensor as described herein. In one example, the luminaire 102 may include a light source 208 configured to illuminate a space 2001, a biosensor 220 capable of sampling air, and an air circulation system 240 capable of drawing air into contact with the biosensor 220 and outputting air sampled, for example, by contact with the biosensor 220 for the presence of a toxin.

The system example of FIG. 1 illustrates a luminaire 102 equipped with a biosensor positioned within an air pathway. The system 10 may include or other luminaires 101, which may or may not be similarly equipped as luminaire 102, as appropriate to both provide suitable general illumination and to provide the appropriate level of biological air sampling at the space 2001. The air pathway (shown in other examples) may be a duct (also shown in other examples) that guides air to be sampled from the space 2001 in which the luminaire 102 is located to the biosensor 220 and out of the duct into the space 2001 as sampled air.

The space 2001 may be any location, such as a premises, or locations serviced for lighting and other purposes by a system 10 of the type described herein. Hence, the example of system 10 may provide lighting, air sampling for the presence of air-borne toxins, and possibly other services in a number of service areas in or associated with a building, such as various rooms, hallways, corridors or storage areas of a building (e.g., home, hospital, office building, schools, and an outdoor area associated with a building). Any building forming, or at, the premises, for example, may be an individual or multi-resident dwelling or may provide space for one or more enterprises and/or any combination of residential and enterprise facilities.

The system elements, in a system like system 10 of FIG. 1, may include any number of luminaires, such as luminaires 102 or 101 one or more of which may be equipped with a biosensor. Luminaire 102 is an example of a luminaire suitable for use in a system of luminaires as described herein that is equipped with a biosensor 220. The luminaire 102 includes a controller 204 that may be configured to control lighting related operations, e.g., ON/OFF, intensity, brightness or color characteristic of the output of the light source 208, and possibly other lighting related functions of the luminaire 102. In addition, controller 204 may be configured to provide biosensor (e.g. health or functional) and/or environmental (e.g. air quality) status monitoring and control of functions related to the proper operation of the biosensor 220, as described in greater detail below. For example, the biosensor 220 is capable of producing the observable indication in response to the presence of carbon monoxide, carbon dioxide, hydrogen gas, hydrogen sulfide, ammonia, ozone, a volatile organic compound (VOC), formaldehyde or the like.

The controller 204 of the luminaire 102 may send commands to the other luminaires 101 that are executed by processing elements, such as controller 204 present in the other luminaires 101. Conversely, the controller 204 of the luminaire 102 may receive and execute commands from another luminaire 101 or from another control device in the system 10 or in communication with the system 10.

The system elements 101 and 102 in a system like system 10 of FIG. 1, may be coupled to and communicate via a data network 17 at the space 2001. The data network 17 in the example may be coupled to one or more luminaires via either a wired or wireless access point (WAP) (not shown) that couples to the network terminal 207 or to the wireless transceiver 206 to support communications at a premises (not shown in this example) including the space 2001. Such communications may be via wired and/or wireless communication media, e.g. cable or fiber Ethernet, Wi-Fi, Bluetooth, cellular or short range mesh. In many installations, there may be one overall data communication network 17 at the premises. For example, the network 17 may enable a user terminal for a user to control operations of luminaire 102 (or other luminaires 101). Such a user terminal is depicted in FIG. 1, for example, as a computing device 27, although any appropriate user terminal such as a mobile device may also be utilized. Network(s) 17 includes, for example, a local area network (LAN), a metropolitan area network (MAN), a wide area network (WAN) or some other private or public network, such as the Internet.

System 10 in the example also includes server 29 and database 31 accessible to a processor of server 29. Although FIG. 1 depicts database 31 as physically proximate server 29, this is only for simplicity and no such requirement exists. Instead, database 31 may be located physically disparate or otherwise separated from server 29 and logically accessible by server 29, for example via network 17.

Database 31 may be a collection of threshold data, such as threshold data 219 for use in conjunction with the biosensor 220. For example, each threshold data within database 31 may include reference data related to the health and growth of the microorganisms of a particular type of biosensor, status of air flow and biosensor light sources and/or other components of the luminaire that influence or respond to the operation of the biosensor, or the like. The threshold data 219 (explained in more detail with reference to another example) may include image data, sensor (e.g. optical, air flow, air quality, temperature or the like) threshold values, or other reference materials that may provide an indicator of the health, growth or status of the microorganisms that forms each available type of biosensor that may be used in a luminaire. In one example, a selected threshold data from among the collection of threshold data is loaded into a memory of the luminaire 102 (or other luminaires 101) for the particular type of biosensor included as biosensor 220 in that luminaire; and the luminaire 102 (or other luminaires 101) may be configured to utilize the selected threshold data to determine the status (e.g. healthy, presence of a toxin, or the like) of the biosensor 220 The threshold data may also be used by the CPU 214 to possibly control one or more components (e.g. flashing of the light source in the presence of a lethal toxin, or the like) of the system 10 to achieve the intended toxin detection via the biosensor 220. That is, the selected reference data enables luminaire 102 (or other luminaires 101) to indicate when the biosensor is operating properly, needs replacement, inspection or servicing (e.g. replacement of nutrients, replacement of biosensor light source, or the like). As another example, the selected reference data may enable luminaire 102 (or other luminaires 101) to respond to sensed condition(s) to control the air circulation system 240 to modify air intake and output from the luminaire 102.

An example of a luminaire 102 is shown in FIG. 1 in which the luminaire 102 includes a housing 103, a light source 208 for general illumination, the biosensor 220, a controller 204, a wireless transceiver 206, air circulation system 240, and a wired network terminal 207. The communication interface 212 may be coupled to a data communication network, such as 17, via either the wireless transceiver 206, the wired network terminal 207, or both. The controller 204 has an internal processor configured as a central processing unit (CPU) 214, a memory 216, a non-volatile memory 218 and the communication interface 212. The processor 214 is coupled to the memories 216 and 218 and the communication interface 212; and the communication interface 212 provides communications for the controller 204 with the light source 208, the biosensor 220 and other luminaire components such as the wireless transceiver 206 and the network terminal 207.

In the example of FIG. 1, any of the threshold data 219 that may be installed in the controller 204 are shown stored in non-volatile memory 218. Of course, either of the memories 216 or 218 may store those threshold data and program instructions for analyzing the biosensor 220 and/or controlling any systems operations related to operation of the biosensor 220. The luminaire 102 may receive a threshold data 219 via the network 17, either the wireless transceiver 206 or the network terminal 207 and the communication interface 212. The threshold data may include information related to data output from sensors 203. For example, the sensors 203 may be sensors such as imaging sensors (e.g., cameras, photodiodes or the like), a spectrometer, a micro-electro-mechanical (MEM) sensor (e.g. pressure sensor), resistive, capacitive, inductive or the like, that respond to an observable or detectable indication of the microorganism. Luminaires 102 and 101 may also be equipped with a spectrometer to monitor the microorganism for an observable or detectable indication of the presence of a toxin. Examples of a luminaire incorporating a spectrometer are disclosed in U.S. patent application Ser. No. 15/247,076, the entire contents of which are incorporated herein by reference.

In some examples, the processor forming the core of CPU 214, when executing the stored program instructions, is configured to perform various functions related to the analysis of signals generated by the sensors 203 and control of any relevant system operations. The processor forming the CPU 214 and associated memories 216 and 218 in the example of the luminaire 102 may be components of the controller 204, which may be a microchip device that incorporates the CPU as well as one or more memories. The controller 204 may be thought of as a small computer or computer-like device formed on a single chip (e.g. a system-o-a-chip (SOC)). Alternatively, the processor forming the CPU 214 and the memory 216 or 218 may be implemented as separate components, e.g. by a microprocessor, ROM, RAM, flash memory, etc. coupled together via a bus or the like. The housing 103 may serve to protect the components of the luminaire 102 from the dust, dirt, water (e.g. rain) or the like in the location in which the device is installed. The terms “processor” and “CPU” may be used interchangeably to refer to CPU 214.

Also included in the example luminaire 102 is a power distribution unit 202 configured to receive power, in the example, from an external alternating current (AC) power source 235. The power distribution unit 202 may, for example, be configured to distribute electrical power to the various components within the luminaire 102. For example, the light source 208 is an artificial light generation device (such as an LED group or array, or the like) configured to generate illumination light upon consumption of electrical power from the power distribution unit 202.

This example of the luminaire 102 includes the capabilities to communicate over one or more radio frequency (RF) bands, although the concepts discussed herein are applicable to control devices that communicate with luminaires and other system elements via a single RF band. Hence, in the example, the luminaire 102 includes a wireless transceiver 206, which may be configured for sending/receiving control signals, for sending/receiving sensor data signals, and/or for sending/receiving pairing and commissioning messages. For example, the transceiver 206 may be one or more transceivers configured as a BLE transceiver; and for such an implementation, a variety of control signals are transmitted over the BLE control band of the wireless control network 5, including, for example, signals for turn lights on/off, dim up/down, set scene (e.g., a predetermined light setting), and sensor trip events. WiFi, sub-GHz or other frequencies/protocols may be used for the wireless control network 5 and transceiver 206 instead of or in addition to the sub-GHz band example. Alternatively, the same transceiver 206 or a second transceiver (not shown) may be configured as a 2.4 GHz transceiver for Bluetooth low energy (BLE) that carries various messages related to commissioning and maintenance of a wirelessly networked lighting system. The wireless transceiver 206 coupled to the communication interface 212 and to a wireless network, such as 5 via the wireless access point 21 of FIG. 1. The wireless transceiver 206 may be, for example, configured to transmit signals related to outputs from the sensor 203 and/or operations of biosensor 220 from the processor 214 to a computing device, such as such as devices 29 and/or 27 of FIG. 1, external to the environment in which the luminaire 102 is located.

In the example of FIG. 1, luminaire 102 is shown as having one processor 214, for convenience. In some instances, the luminaire may have multiple processors. For example, a particular device configuration may utilize a multi-core processor architecture.

In general, the controller 204 of the luminaire 102 controls the various components or devices included in the luminaire 102, such as the light source 208 and the biosensor 220, connected to the controller 204. For example, controller 204 may control one or more included RF transceivers 206 to communicate with other RF devices (e.g. wall switches, sensors, commissioning device, etc.). In addition, the controller 204 controls the light source 208 to turn ON/OFF automatically, or at the request of a user. In addition, controller 204 controls other aspects of operation of the light source 208, such as light output intensity level, or the like.

For example, the controller 204 may be responsive to signals received from various control devices coupled to the system 10. An example of a control device is a user control, such as 255. The user control 255 may also be coupled to the controller 204 of luminaire 102 or the control 255 may communicate with the luminaire, for example, via wireless communication with transceiver 206. The user control 255 may be configured to output signals related to lighting ON/OFF, dimming control, heating, ventilation, and air conditioning (HVAC) that may be provided to the luminaire 102 and/or to the building control and automation system (BCAS) gateway 109. The BCAS gateway 109 may be a centralized controller of a building system such as HVAC, physical security, lighting, elevators and the like.

In the example luminaire 102, the controller 204 may also be coupled to an air circulation system 240. The air circulation system 240 may include ducting and a fan that are configured to transport air from the environment in which the luminaire 102 is located toward the biosensor 220 for sampling of the transported air, and return of the sampled air to the environment in which the luminaire is located. Alternatively or in addition, the air circulation system 240 may be coupled to an HVAC system (not shown) which may transport air into the ducting in place of, or to supplement, the air transported by the fan in the air circulation system 240.

The system 10 may include one or more sensors 203. The sensors 203 may be sensors that detect a response by the microorganism (shown in a later example) indicating the presence of a toxin in the sampled air. Examples of suitable sensors 203 may include imaging sensors (e.g., cameras, photodiodes or the like), color detectors, resistive, capacitive, inductive or the like. Examples of responses of the microorganisms to the presence of a toxin may include changes in appearance (such as color, or size), growth rate, electrical properties, or the like.

The luminaire 102 may couple to a network, such as network 17 or 5 of FIG. 1, for wired communication through the network terminal 207 and/or connected for wireless communication wireless transceiver 206. In the example, internally, the network terminal 207 and the wireless transceiver 206 connect through the interface 212 to communicate with the CPU 214 of the controller 204.

The luminaires 101 and 102 may take various forms. It may be helpful to discuss an example of a general arrangement of a luminaire suitable for use as luminaires 101 or 102.

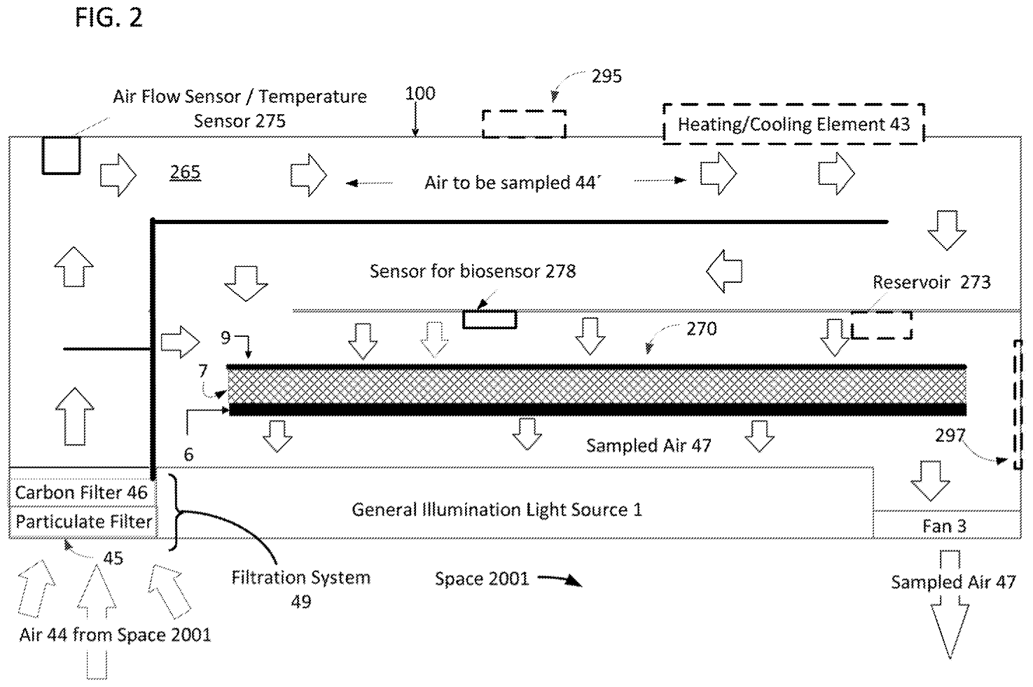

FIG. 2 illustrates a cross sectional example of a luminaire containing a biosensor. The example luminaire 100 includes a general illumination light source 1, a biosensor 270, ducting 265, sensors 275 and 278, and a fan 3. In this example, the light source 1 may be configured to illuminate a space, such as space 2001. The light source 1 may be a general illumination light source configured to illuminate the space 2001 in which the luminaire 100 is located. Although not shown in the present example, the light source 1 may include multiple light sources, such as a general illumination light source directed to emit light into space 2001 as well as an ultraviolet (UV) or near UV light source that functions as a germicide and irradiates air and/or surfaces in the space 2001.

The biosensor 270 is capable of sampling air via, for example, contact of air with the biosensor or by passage of the air through the biosensor. An air circulation system (e.g. to implement system 240 in FIG. 1) may include ducting 265 and the fan 3. The fan 3 may be configured to draw air from space 2001 into the ducting 265. The fan 3 may be a single fan or may be a number of fans that cooperate to draw air into the ducting 265 and distribute the air over a surface of the air permeable media 9 of the biosensor 270. The fan 3 and ducting 265 enable the drawn in air to contact with the microorganism(s) of the biosensor 270. One example of the fan 3 may be a system of fans that controllably cooperate to draw air into contact with microorganisms on the substrate and outputting sampled air 47 following sampling of the air by the microorganism 7 within the biosensor 270. Such a fan system may, for example, include a number of fans of the same or different airflow capacities (e.g. measured in cubic feet per second/minute or the like). Within the ducting 265 may be structural supports (not shown) in a particular location of the ducting 265 that positions the biosensor 270 within the air flow path to allow the air to be sampled 44′ to come into contact with the biosensor 270.

The microorganism 7 of the biosensor 270, for example, is configured to respond to a toxin, such as a gas, bacteria, virus, air-borne particulates, odiferous solid or liquid, a toxic synthetic material and/or toxic biological material, in the air to be sampled 44′. The sensor for the biosensor 278 may detect the microorganism 7's response to the presence of the toxin and output a raw signal (some electrical current or voltage value) or a processed signal as data, such as a digital signal representing, for example, some relative concentration of the toxin causing the particular response, image data, if the senor is a camera, a voltage value if the sensor is current-driven and uses a resistive or capacitive element, or the like.

The air circulation system may also be supplemented with or replaced with a filtration system 49. The filtration system 49 may be configured to condition the air in order to maximize the ability of the microorganisms to sample the air as described herein. The filtration system 49 may include a humidifying system, a temperature control system, a particulate filter, a carbon filter, an ultraviolet (UV) light source, or any combination thereof. For ease of illustration, only the ultraviolet (UV) light source 42, the particulate filter 45 and the carbon filter 46 of the filtration system 49 are shown, but may also be omitted in some examples.

Optional components in the luminaire 100 may include one or more attachment points 295 for use in securing the luminaire 100 when the luminaire 100 is implemented as a pendant light, sconce-like fixture, a wall-wash implementation, or the like. In another optional example, the luminaire 100 may also include an access port 297. The biosensor 270 may be configured to be inserted into and removed from the luminaire 100 via the access port 297, e.g. for installation and/or replacement. Alternatively or in addition, the access port 297 may be configured to (1) add a liquid medium (not shown in this example) to the substrate 6, (2) remove a liquid medium from the substrate 6, (3) add a liquid medium to the substrate 6 and remove a liquid medium from the substrate 6, or (4) be transparent to allow for visual inspection of the microorganism.

In another example, substrate may include water and nutrients for the microorganism. In yet another example, the luminaire 100 may also contain a replaceable or refillable liquid reservoir 273. In one example, the liquid contained in the reservoir contains an aqueous medium that provides nutrients and other substances for maintaining the viability of the microorganism or algae. The reservoir 273, in some examples, may be a dual chamber container in which a first container contains the aqueous medium while the second chamber may be configured to contain waste materials from the microorganisms. The ducting 265 of the luminaire 100 may also include a heating/cooling element 43 that may be coupled to and controlled by the controller 204 of FIG. 1. The heating/cooling element 43 may be configured to either heat or cool the air to be sampled 44′ as the air moves through the ducting prior to interacting with the biosensor 270.

The air to be sampled 44 interacts with the biosensor 270 (e.g. by contact with microorganisms (not shown in this example) of the biosensor 270) after which the sampled air 47 is returned to at least a portion of the space 2001 illuminated by the light source 1. The air to be sampled 44′ that contacts with the biosensor 270 is sampled by the microorganism for a toxin, and the sampled air 47 is output to at least a portion of the space 2001 illuminated by the light source 1.

In the example of FIG. 2, the biosensor (270) includes a substrate 6, a microorganism 7 immobilized in and/or on the substrate 6, and an air-permeable membrane 9. The air-permeable membrane 9 may be hydrophobic. Suitable materials for the membrane 9 include, for example, Tyvek®, GOR-TEX®, or silicones and fluoropolymers, such as Teflon®.

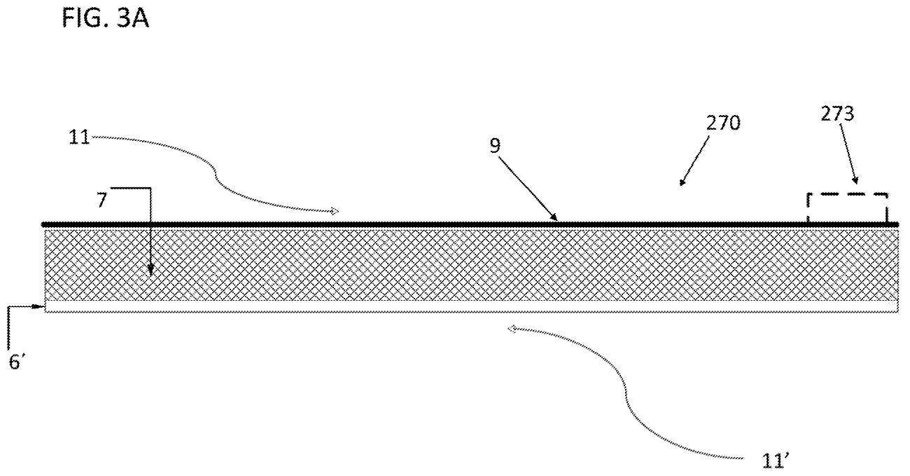

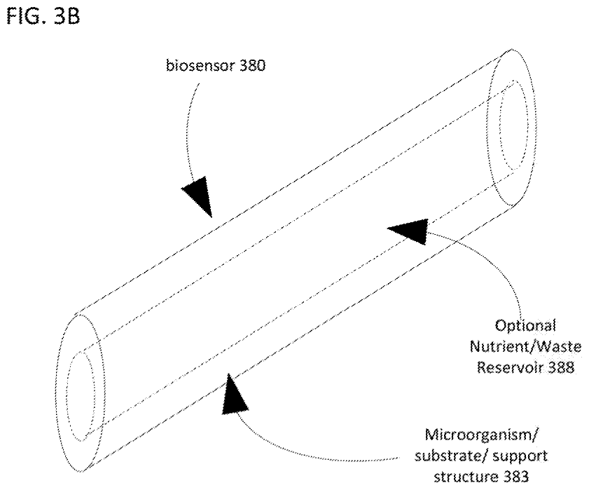

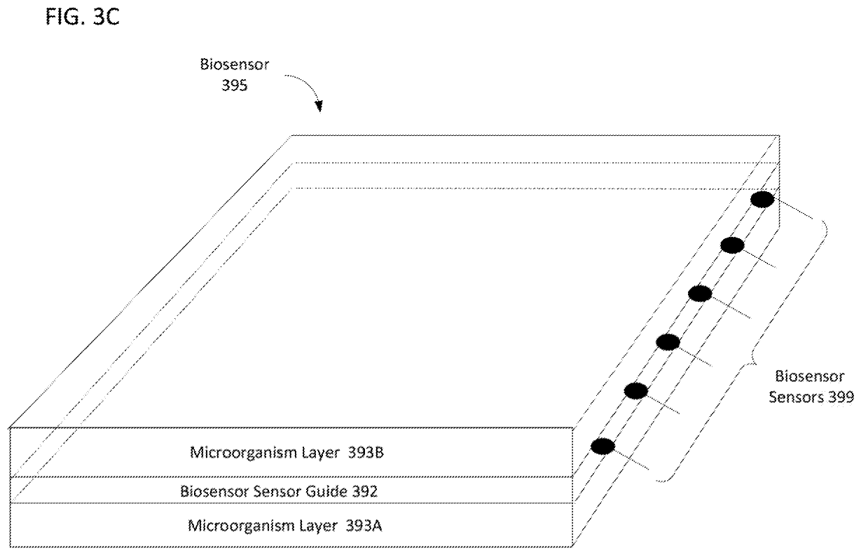

The flow of the air to be sampled 44′ through the ducting 265 may come into contact or pass through the biosensor 270. The toxin detection functions of the biosensor 270 are discussed in more detail with reference to other examples. It may be appropriate at this time to discuss the biosensor 270 in more detail with reference to FIG. 3.

FIG. 3A illustrates an example of a biosensor usable in the luminaire examples of FIG. 1 or 2. FIG. 3 shows air flow (11) and (11′) across the air permeable membrane 9 and the substrate 6. A microorganism 7 is immobilized in and/or on the substrate 6. The respective microorganism 7 is described below in more detail with reference to another example.

In some examples, the luminaire 100 has a slot or holder into which the biosensor can be inserted. In some examples, the biosensor is in the form of a “cartridge” or “cassette” that can be easily inserted and removed from the luminaire, much in the same way that disposable air filters are used in household furnaces. In some examples, the cartridge or cassette is formed from a metal, plastic or paper material.

The microorganisms may be structurally supported within the respective biosensors by use of a number of various materials. Representative examples of packing materials used therein are described in (1) Anet et al., “Characterization and Selection of Packing Materials for Biofiltration of Rendering Odourous Emissions,” Water Air Soil Pollut (2013), 224, 1622, (2) “A Review of Biofiltration Packings,” revised Aug. 15, 2013 on the World Wide Web at .biofilters.com/webreview.htm, (3) U.S. Pat. No. 8,758,619, (4) Estrada et al. “A Comparative study of fungal and bacterial biofiltration sampling a VOC mixture.” 2013, Journal of Hazardous Materials, 250-251, 190-197, (5) Kennes et al. “Bioprocesses for air pollution control.” 2009, J Chem Technol Biotechnol, 84, 1419-1436, (6) Prachuabmom, A., and Panich, N. “Isolation and Identification of Xylene Degrading Microorganisms from Biosensor.” 2010, Journal of Applied Sciences, 10, 7, 585-589, (7) Priya, V. S., and Philip, L. “Biodegradation of Dichloromethane Along with Other VOCs from Pharmaceutical Wastewater.” 2013, Appl Biochem Biotechnol, 169, 1197-1218, (8) Yoshikawa et al. “Integrated Anaerobic-Aerobic Biodegradation of Multiple Contaminants Including Chlorinated Ethylenes, Benzene, Toluene, and Dichloromethane.” 2017, Water Air Soil Pollut, 228, 25, 1-13, (9) Yoshikawa et al. “Bacterial Degraders of Coexisting Dichloromethane, Benzene, and Toluene, Identified by Stable-Isotope Probing.” 2017, Water Air Soil Pollut, 228, 418, 1-10, and (10) Yoshikawa et al. “Biodegradation of Volatile Organic Compounds and Their Effects on Biodegradability under Co-Existing Conditions” 2017, Microbes Environ, 32, 3, 188-200. The entire contents of each of which are incorporated herein by reference.

FIG. 3B illustrates a plan view of an example of a cylindrical biosensor configuration. In the example of FIG. 3B, the biosensor 380 may include an Optional Nutrient/Waste Reservoir 388. The optional Nutrient/Waste Reservoir 388 may be substantially surrounded by the microorganisms/substrates and support structures (the details of which are described with reference to other examples). The Nutrient/Waste Reservoir 388 may have two chambers (not shown): a first chamber for a nutrient enriched aqueous solution and a second chamber for a waste reservoir that stores waste generated by the microorganism/substrate/support structure 383.

FIG. 3C illustrates a plan view of a rectangular biosensor configuration. The biosensor 395 may be configured with a biosensor light guide sandwiched between two microorganism layers 393A and 393B. The microorganisms forming the microorganism layers 393A and 393B may be the same or different. For example, both microorganism layers 393A and 393B may respond to the presence of carbon dioxide or the like. Alternatively, one layer, such as microorganism layer 393A, may be responsive to carbon monoxide while the other layer, such as microorganism layer 393B, may be responsive to formaldehyde, carbon dioxide or the like. The biosensor sensor guide 392 may be configured to enable the respective biosensor sensors 399 to detect any indications of toxins in the sampled air. The biosensor sensors 399 may be sensors such as those described with respect to the examples of FIGS. 1-3A. The biosensor sensor guide 392 may be configured to distribute any emission indicating the presence of a toxin in the sampled air from the microorganism layers 393A and 393B. For example, the biosensor sensors 399 may be cameras, photodetectors, resistive, capacitive, inductive or other types of sensors that provide an output based on a detected change in either or both of the microorganism layers 393A or 393B. One or more of the respective sensors of the biosensors 399 may output a signal based on detection of an indication by one or both microorganism layers 393A and 393B of the presence of a toxin.

The biosensor in the examples described herein, such as 220, 270, or 395 may be used for sampling air, where the air flows over and/or through an air-permeable membrane to contact the microorganism. If a toxin is present in the sampled air, the microorganism reacts to the presence of the toxin by producing a detectable or observable indication of the presence of a toxin.

As discussed above with reference to the examples of FIGS. 1 and 2, the luminaires 100 and 102 may contain a live microorganism 7 that is capable of sampling air. The identity of the microorganism is not particularly limited.

A variety of different microorganisms 7 may be used in the biosensor 270. It should be noted that the microorganisms 7 may be the same or different. For example, three classes of microorganisms that may be useful include bacteria, algae, and fungi. The microorganisms, bacteria and green algae are especially useful.

A luminaire equipped with a biosensor, a sensor for the biosensor and a processor configured to process and/or analyze an output of the sensor for the biosensor generally refers to an analytical device used for the detection of an analyte, such as a toxin, in air sampled by the biosensor. Suitable biosensors are well-known in the art, see, for example, (1) Eltzov et al., “Bioluminescent Liquid Light Guide Pad Biosensor for Indoor Air Toxicity Measuring,” Analytical Chemistry, 2015, 87 3655-3661; (2) Gil et al., “A biosensor for the detection of gas toxicity using recombinant bioluminescent bacterium,” Biosensors and Bioelectronics, 15, March 2000, 23-30; (3) Bohrn et al., “Monitoring of irritant gas using a whole-cell-based sensor system,” Sensors and Actuators B: Chemical, 175, December 2012, 208-217; (4) Bohrn et al., “Air Quality Monitoring using a Whole-Cell based Sensor System,” Procedia Engineering, 25, 2011, 1421-1424; (5) Chatterjee et al., U.S. Pat. No. 6,471,136; (6) Aisyah et al., “Exploring the Potential of Whole Cell Biosensor: A Review of Environmental Applications,” International Journal of Chemical, Environmental & Biological Sciences (IJCEBS), 2, 2014, 52-56; (7) Dai et al., “Technology and Applications of Microbial Biosensor,” Open Journal of Applied Biosensor, 2013, 2, 83-89; or (8) Sandstroem et al., “Biosensors in air monitoring,” J Environ. Monit., 1999, 1, 293-298. The entire contents of each of which are incorporated herein by reference.

Using well-known protocols, the biosensor may be configured to provide qualitative information regarding the presence of the toxin. However, in another example, the biosensor can be configured to provide quantitative information regarding the concentration of toxin in the air.

The nature of the airborne toxin to be detected in the air to be sampled is not particularly limited. Toxins may be, for example, any of the well-known pollutants which are common in indoor habitable living spaces. Toxins may include carbon monoxide, carbon dioxide, hydrogen gas, hydrogen sulfide, ammonia, ozone, particulates, and volatile organic compounds (VOCs) such as methane, ethanol, toluene, and formaldehyde. Specific toxins are also described in the references relating to biosensors discussed above.

The nature of the microorganism used to detect toxins in the air to be sampled is not particularly limited. A wide variety of microorganisms capable of producing an observable indication in response to the presence of a toxin in the air are known and may be used in the luminaire. Bacteria are a preferred example of microorganism that can be used in the biosensor. Genetically-engineered bacteria are particularly suitable for use in the biosensor. Bioluminescent bacteria are particularly preferred and well-known in the art. A particularly preferred bacteria is E. coli. Examples of microorganisms that can be used in the biosensor are described in the references cited above with respect to biosensors and throughout the present discussion.

The substrate 6 may be implemented in a number of different configurations. In some examples, the biosensor includes a substrate that is suitable to maintain the viability of the microorganism. Considerations for selecting the substrate may include (1) the ability to retain moisture to sustain the microorganism and especially a biofilm layer as described herein, (2) a large surface area, both for contaminant absorption and growth of the microorganism, (3) the ability to retain nutrients and supply them to microorganism as required, (4) low resistance to air flow (minimizes pressure drop and air circulation power requirements), or (5) physical characteristics, such as physical stability and ease of handling. The air flows over the surface of or through the substrate 6 so that the microorganism 7 may condition the air. The air may, in some examples, flow over the surface of the substrate 6 and through the substrate 6.

Generally, the substrates 6 may include any material that may structurally support the microorganism 7 and remain permeable to the air to be sampled. In some examples of the luminaire 100, the support has a high surface area which is covered by the microorganism. In an example of the luminaire, the microorganism forms a biofilm over the support. An example of a suitable material is an alginate.

The substrate 6 may have pores which facilitate the flow of air. The pore size is not particularly limited and is preferably 1 to 5 times the size of the microorganism 7. A preferred pore size is 1 to 10 μm in substrate examples that contain pores.

The substrate 6 in some examples have a packed bed (not shown) containing a packing material. The microorganism in such examples may be located in and/or on the packed bed. For example, the microorganism may be in the form of a biofilm on the packed bed. Examples of the packing material may include, for example, glass particles, ceramic particles, gravel particles, plastic particles, activated charcoal, or a combination thereof. Particles in the form of beads are especially suitable. The packing material (not shown) may, for example, be compost, soil, heather, peat or the like. In the example, the microorganism generally grows on or over the packing material.

In one example, the support for the microorganism comprises a replaceable hydrogel. Commonly used components of hydrogels include alginates (see, for example, Eltzov et al., “Bioluminescent Liquid Light Guide Pad Biosensor for Indoor Air Toxicity Measuring,” Analytical Chemistry, 2015, 87 3655-3661), polyvinyl alcohol, sodium polyacrylate, acrylate polymers and copolymers thereof with an abundance of hydrophilic groups. Natural hydrogel materials may also be used, including agarose, methylcellulose, hyaluronan, Elastin like polypeptides and other naturally derived polymers. The hydrogel may be overlaid on a substrate, such as 6 of FIG. 2, and be replaced after some time period. In another example, the substrate 6, microorganism 7, and the air permeable membrane 9 of the biofilter 270 may be formed from a hydrogel, and be removable from the light guide and be replaced with a new replacement substrate 6, microorganism 7, and the air permeable membrane 9 may be inserted into the biofilter 270 after some predetermined time period. In another example, the substrate may contain a wicking material. In yet another example, the substrate may be composed of a hollow fiber membrane. In some examples, a biofilm formed from the microorganism may form on the hollow fiber membrane.

In some of the examples, the substrate 6 may contain a medium, such as water and nutrients, to provide continued viability and sustenance for the microorganism. The medium may be referred to as a liquid medium or an aqueous medium. This medium may also function to contain waste products produced by the microorganism. Examples of nutrients include carbohydrates, proteins, peptides, amino acids, lipids, vitamins, inorganic salts, and co-factors. A specific example of suitable nutrient is glucose. The components of such media are well-known in the art.

Most nutritional media contains 1.5% agar and 0.5% peptone. In an example, where the microorganism may use the carbon in the VOCs, the VOCs may not need a supplemented carbon source (such as glucose or malt). Most bacteria thrive in pH neutral medium, while yeast and molds prefer acidic, 5.4-5.6 pH.

In some examples, the substrate is maintained at a moisture content of 30% to 60% in order to support the population of the microorganism. The liquid component discussed herein may also contain a chemical buffer in order to control pH. A preferred chemical buffer pH is around 7.0.

The flow rate of air across and/or through the substrate, such as 6, and thus the residence time may vary widely. The “residence time” represents the amount of time the microbes are in contact with the air stream, and is defined, for example, by void volume/volumetric flow rate or the like. Consequently, longer residence times produce higher efficiencies; however, a design can minimize residence time to allow the device to accommodate larger flow rates. For example, the residence time may range between 30 seconds to 1 minute.

The pressure drop across the substrate, such as 6 may be minimized since an increase in pressure drop requires more air circulation and can result in air channeling through the media (e.g. microorganisms). The pressure drop may be directly related to the moisture content in the media and the media pore size. Increased moisture and decreased pore size may result in increased pressure drop. Consequently, media filter selection and watering may be relevant to evaluating the performance and energy efficiency of the luminaire, such as 100 or 102. For example, the pressure drops may range between 1 and 10 hPa. In addition, the air permeability of air permeable surfaces such as 9 may also be considered.

In some examples, the substrate may contain more than one layer containing a microorganism. For example, the substrate may contain two or more different layers where different microorganisms are present in each layer. An example of a biosensor containing such a structure is shown in FIG. 3C as described above.

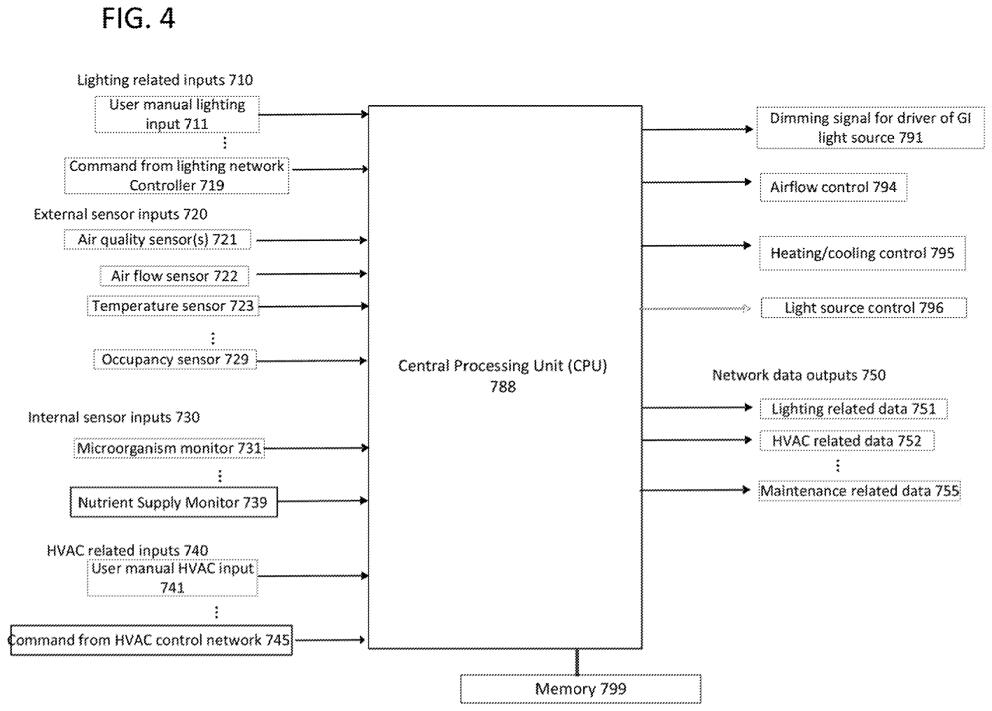

It may now be beneficial to describe in more detail the control of the air sampling and lighting capabilities of the luminaire described in the foregoing examples. As shown in the example of FIG. 1, luminaire 102 includes the processor 204 for control of the lighting and air sampling operations. FIG. 4 illustrates a diagram of an example of a central processing unit for controlling operation of an example of a luminaire, such as those described with reference to FIGS. 1 and 2.

The central processing unit (CPU) 788 of FIG. 4 (also referred to as a “processor”) may be coupled to a number of different systems, sensors, and computing devices, such as 27 and 29 of FIG. 1. For example, the CPU 788 may receive lighting related inputs 710, external sensor inputs 720, internal sensor inputs 730, and HVAC related inputs 740. The computing devices may rely on the outputs from the CPU 788 to determine the status of the luminaire or information related to air quality or the like.

The luminaire examples described herein may be used to provide general illumination light and sample air in the space in which the luminaire is located. The CPU 788 may be configured to provide functions, such as controlling: (1) emission of light from a general illumination light source in the luminaire to illuminate a space, (2) the drawing of air into contact with a biosensor in the luminaire for sampling of the air when the air contacts the biosensor; and (3) outputting air sampled by contact with the biosensor into at least a portion of the space illuminated by the light source.

The CPU 788 may be configured to perform the above control functions as well as other functions by executing programming code stored in the memory 799. The memory 799 may be one or more memories, such as 216 and 218 of FIG. 1. The CPU 788 may be configured upon execution of the programming code to respond to and/or process the respective inputs. For example, the lighting related inputs 710 may include user manual lighting inputs 711, commands from a lighting network controller 719, or the like. The external sensor inputs 720 may, for example, include air quality sensors 721, air flow sensors 722, temperature sensors 723, an occupancy sensor 729, or the like. The internal sensor inputs 730 may, for example, include a microorganism monitor 731, nutrient supply monitor 739, or the like. The HVAC related inputs may include user manual HVAC inputs 741, commands from the HVAC control network 745 (e.g., BCAS gateway 109 of FIG. 1), or the like. The microorganism monitor 731 may be one or more sensors, such as sensors for the biosensor 203 of FIG. 1 or 278 of FIG. 2.

The manual user inputs for lighting (i.e. 711) and HVAC (i.e. 741) may be provided by a user control, such as 255 of FIG. 1. Based on the different inputs, the CPU 788 may be configured to output one or more signals. For example, the CPU 788 may output a dimming signal to the driver of the general illumination source to dim or increase the intensity of the general illumination light emitted by the general illumination light source (shown in other examples). In addition, the CPU 788 may output signals specific to the air sampling functions, such as airflow control 794. In response to and user manual lighting inputs 711, the CPU 788 may control the respective light sources to perform the task requested by the inputted request, such as a light source control 796 function (e.g., ON/OFF) or a dimming signal 791 function. Alternatively, the CPU 788 may output a light source control 796 signal in response to an input from an occupancy sensor 729 input. In addition, the CPU 788 may respond to inputs 719 from a lighting network controller or the like, such as a BCAS gateway or other luminaire via a wireless control network, by outputting a dimming signal 791 or a light source control 796 signal.

For example, in response to user manual HVAC inputs 741, the CPU 788 may output a heating/cooling control 795 signal for execution of the requested function associated with the user input. Alternatively, the CPU 788 may output a heating/cooling control 795 signal in response to an input from temperature sensor 723 input. In some examples, the heating/cooling control 795 may control the heating/control element 43 in the ducting as shown in FIGS. 2 and 4. The CPU 788 may output other potential control signals, such as controlling, if available, a UV light source that outputs germicidal irradiation 793. The CPU 788 may also control the airflow (794) in response to one or more inputs, for example, from the air quality sensor(s) 721 and/or airflow sensor 722.

The luminaire CPU 788 may be configured with programming to provide one or more features additional to the features described above.

The CPU 788 may also output data for use by computing devices, such as 27 and 29, connected to the luminaire. For example, the computing devices may receive network data outputs 750 such as lighting related data 751, HVAC related data 752, toxin data or maintenance related data 755.

The CPU 788 upon execution of the programming code stored in the memory 799 may also perform control algorithms related to generating an alarm in response to the detection of a toxin by the biosensor.

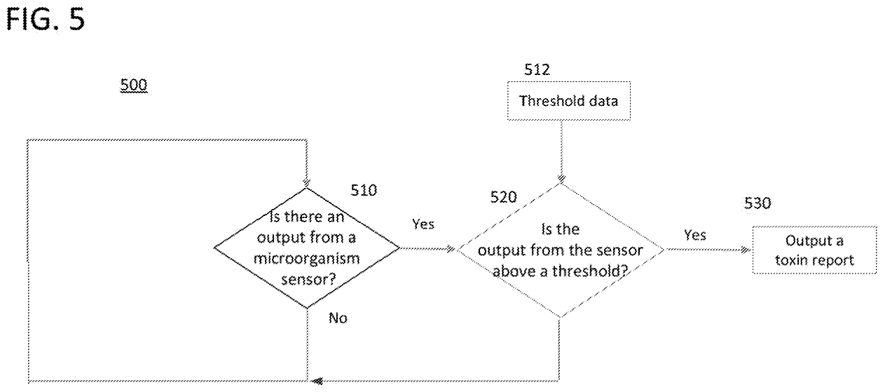

FIG. 5 illustrates a flowchart of an example process utilizing examples of the biosensor described above. The process 500 may be implemented by a processor, such as processor 214 of controller 204 in FIG. 1. The following discussion of the process 500 will be discussed with reference to the fixture 102 of FIG. 1.

In an example, the microorganism 7 of the biosensor 220 may be responsive to a toxin, such as, for example, carbon monoxide (CO) gas. In the example, the sensor 203 is coupled to the controller 204 via the communication interface 212. The sensors 203 may output data in response to a detectable or observable indication generated by the microorganism 7. For example, one of the types of sensors 203 may be a camera or a photodetector capable of detecting a change in color. The microorganism in the biosensor 220 may be responsive to the presence of a toxin. The sensor 203 may be configured to detect a response by the microorganism to the CO gas in the air to be sampled.

The processor 214 may continuously or periodically monitor the output of the sensor 203 at 510. For example, if the processor 214 does not receive data signal output by the sensor 203, it is determined at 510 that there is no output from the sensor 203, and the process 500 returns after some time to determine whether an output from the sensor 203 is received.

Alternatively, if the processor 214 receives a data or a signal output by the sensor 203, the processor 214 may determine at 510 that there is an output from the sensor 203.

In response to the determination, “Yes, there is an output from the microorganism sensor” at 510 by the processor 214. The process 500 executed by the processor 214 proceeds to 520, where the output from the sensor 203 may be processed and/or analyzed by the processor 214. The processor 214 may access, at 512, threshold data 219 stored in memory 218 to determine whether the output from the sensor 203 is above a threshold data value. At 520, the processor 214 may, during the analysis, compare data received from the sensor 203 to the threshold data 219. The threshold data 219 may include a value indicative of the microorganism's response to a harmful concentration of CO gas as well as other data, such as concentration level or the like.

Based on the results of the comparison at 520 indicating that the output of the sensor is above a threshold, the processor 214 of the controller 204 may output, at 530, a report of the detected toxin. For example, the wireless transceiver 206 that is coupled to the communication interface and to a wireless network, may be configured to transmit the report of the detected toxin output by the processor to a device, such as 27 and/or 29 of FIG. 1, external to the environment in which the lighting device 102 is located. A report, for example, may be an output signal indicating the presence of a toxin, or may be a list of values that correspond to an identifier of the detected toxin. Alternatively, if the results of the comparison at 520 indicate that the output of the sensor is below a threshold, the processor 214 of the controller 204 may return to step 510 of the process 500.

The report output at 530 may be sent to an external device such as computer 27, or server 29 and/or database 31 as shown in FIG. 1. The processor 214 in addition, or alternatively, to outputting the report may also adjust an output of the light source 208 in response to a predetermined output report. For example, in response to the detection of a high level of carbon monoxide in the output report, the processor 214 may control the light source 208 to output light that flashes between full intensity and a lower intensity that is noticeable to occupants in the area illuminated by the lighting device 102, and indicative of an alarm condition.

In a further example of the operation of the example of FIG. 2, the processor 214 is coupled to the memory 216, 218, the communication interface 212, the light source 208 and the sensors 203. The processor 214 may receive via the communication interface 212 updated threshold data. The updated threshold data may include updated threshold data that uniquely identifies a response of a microorganism that may be within the biosensor 220 for comparison to a detectable or observable output by microorganism 7.

The processor 214 is configured to communicate information included whether a toxin was detected by the microorganism 7 over a network via the communication interface 212. For example, the processor 214 may receive from a sensor 278 a signal containing sensor data that was generated in response to a detectable or observable output from the microorganism 7. The processor 214 (labeled “CPU”) of the controller 204 may access the stored threshold data in the memory 216 and/or 218, and analyzes the signal received from the sensor 278 with respect to the threshold data stored in the memory 216 and/or 218 to determine, for example, a presence of a toxin in the air in a measurement volume (explained in more detail with reference to the examples of FIGS. 3-10). For example, the threshold data stored in the memory 219 may be a data value representative of a level of a toxin detected by a particular sensor that is, or is potentially, harmful to a human in the space 2001.

While the above examples are described with reference to a luminaire with a biosensor in which the biosensor is configured to sample the air that interacts with the biosensor, the luminaire may also be equipped with both a biosensor and a biofilter. A biofilter may be a device that treats the air that contacts the biofilter. Examples of such a biofilter are described in Applicant's contemporaneously filed patent application entitled Luminaire with Biofilter (Attorney Docket no.: ABL-252US), the entire contents of which are incorporated herein by reference.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ±10% from the stated amount.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

1. A luminaire, comprising:
a light source configured to illuminate a space,
a biosensor capable of producing an observable indication in response to the presence of a toxin in the air, wherein the biosensor comprises:
a substrate which is permeable to the air, and
a microorganism present on a surface of the substrate, in the substrate, or a combination thereof, and
an air circulation system capable of drawing air into contact with the biosensor, wherein the air circulation system comprises:
a fan configured to move the air in one direction to contact the microorganism of the biosensor.

2. The luminaire of claim 1, wherein the biosensor is capable of producing the observable indication in response to the presence of carbon monoxide, carbon dioxide, hydrogen gas, hydrogen sulfide, ammonia, ozone, or a volatile organic compound (VOC).

3. The luminaire of claim 1, wherein the biosensor is capable of producing the observable indication in response to the presence of carbon monoxide, carbon dioxide, or formaldehyde.

4. The luminaire of claim 1, wherein the observable indication in response to the presence of the toxin in the air is a color change.

5. The luminaire of claim 1, wherein the microorganism is capable of producing an observable indication in response to the presence of the toxin in the air.

6. The luminaire of claim 5, wherein the microorganism is genetically modified to produce a color change in the presence of the toxin.

7. The luminaire of claim 5, wherein the microorganism is bioluminescent.

8. The luminaire of claim 5, wherein the microorganism is E. coli.

9. (canceled)

10. The luminaire of claim 5, wherein the substrate comprises a hydrogel.

11. The luminaire of claim 10, wherein the hydrogel comprises an alginate.

12. The luminaire of claim 5, wherein the substrate comprises water and nutrients for the microorganism.

13. The luminaire of claim 5, wherein the substrate comprises an air-permeable membrane.

14. The luminaire of claim 1, wherein the light source is capable of emitting white light.

15. The luminaire of claim 1, wherein the light source comprises a light-emitting diode (LED).

16. (canceled)

17. The luminaire of claim 1, further comprising a filtration system, wherein the filtration system comprises a humidifying system, a temperature control system, a particulate filter, a carbon filter, or a combination thereof.

18. A system, comprising:
the luminaire of claim 1, and
a controller coupled to control light from the light source and the air circulation system.

19. A method, comprising:
emitting light from a light source in a luminaire to illuminate a space;
drawing air in one direction from at least a portion of the space illuminated by the light source into contact with a biosensor in the luminaire; and
in response to a presence of a toxin in the drawn in air, producing an observable indication of the presence of the toxin.

20. The method of claim 19, further comprising:
outputting air after contact with the biosensor into at least a portion of the space illuminated by the light source.

21. The method of claim 19, further comprising:
detecting the observable indication, wherein the observable indication is produced by an microorganism of the biosensor in response to the presence of a toxin in the drawn-in air.

22. A system, comprising
a luminaire including:
a light source configured to illuminate a space,
a biosensor capable of producing an observable indication in response to the presence of a toxin in the air,
an air circulation system capable of drawing air in one direction into contact with the biosensor, and
an air filtration system for filtering the air drawn in the one direction into contact with the biosensor by the air circulation system; and
a controller coupled to the luminaire, the controller being configured to control light from the light source and airflow through the air circulation system.
